(19) United States
(12) Patent Application Publication
(10) Pub. No.: US 2013/0048730 A1
(43) Pub. Date: Feb. 28, 2013

(54) TERMINAL DEVICE

(71) Applicant: Mitsuyo SATA, Kawasaki (JP)

(72) Inventor: Mitsuyo SATA, Kawasaki (JP)

(73) Assignee: FUJITSU MOBILE COMMUNICATIONS LIMITED, Kawasaki-shi (JP)

(21) Appl. No.: 13/571,430

(22) Filed: Aug. 10, 2012

(30) Foreign Application Priority Data
Aug. 24, 2011 (JP) 2011-182811

(51) Int. Cl. G06K 7/10

(52) U.S. Cl. 235/462.11

(57) ABSTRACT

A terminal device serving as a receiver side of a data transmission system includes an imaging unit configured to take an image of each of a plurality of two-dimensional codes displayed on a sender side of the data transmission system, the two-dimensional codes being converted from original information to be transmitted from a sender side of the data transmission system, and a change detecting unit configured to determine a change in contents of the two-dimensional codes by detecting a change in a direction of each of the images taken by the imaging unit from a partial area of pictures of the images of the two-dimensional codes displayed on the sender side so as to reproduce the original information from the images corresponding to the two-dimensional codes based on the determined changes in contents of the two-dimensional codes.

### CROSS-REFERENCE TO RELATED APPLICATION

This patent application is based upon, and claims the benefit of priority of Japanese Patent Application No. 2011-182811 filed on Aug. 24, 2011, the entire contents of which are incorporated herein by reference.

### FIELD

The embodiments discussed herein are related to a terminal device.

### BACKGROUND

There has been developed a technology to transmit information utilizing a two-dimensional code such as a quick response (QR) code (a registered trademark). Further, there has been developed a technology to transmit a large amount of data utilizing two-dimensional codes (e.g., Japanese Laid-open Patent Publication No. 2006-139349). In this technology, a sender side divides information into subsets and converts the subsets of the information into plural two-dimensional codes so as to sequentially display the two-dimensional codes on a display device. Thereafter, a receiver side scans the plural two-dimensional codes sequentially displayed on the display device as moving images and sequentially decodes the plural two-dimensional codes so as to reproduce the subsets of information. In this fashion, a large amount of data may be transmitted utilizing the two-dimensional codes.

In order to sequentially transmit the above plural two-dimensional codes, the two-dimensional codes may need to be synchronized between the sender side and the receiver side. There is disclosed a first example of the related art method for synchronizing the two-dimensional codes between the sender side and the receiver side. The method includes shifting positions of the two-dimensional codes displayed on the display device and causing the receiver side to detect changes in the shifted positions of the two-dimensional codes. Further, there is disclosed a second example of the related art method for synchronizing the two-dimensional codes. The method includes changing colors of the two-dimensional codes displayed on the display device and causing the receiver side to detect changes in colors of the two-dimensional codes. Moreover, there is disclosed a third example of the related art method for synchronizing the two-dimensional codes. The method includes changing sizes of the two-dimensional codes displayed on the display device and causing the receiver side to detect changes in the sizes of the two-dimensional codes.

### RELATED ART DOCUMENT

Patent Document 1: Japanese Laid-open Patent Publication No. 2006-139349

However, in the first example of the related art method for synchronizing the two-dimensional codes by shifting positions of the two-dimensional codes displayed on the display device and causing the receiver side to detect changes in the positions of the two-dimensional codes, shaking motion of the two-dimensional codes caused by a user's hand-shake movement may erroneously be detected as the changes in the positions of the two-dimensional codes. Further, in this case, when a frame is displayed on the display device and the two-dimensional codes smaller than the frame are displayed within the frame, a data transmission rate per unit area may be lowered. In addition, all the images within the frame need to be analyzed in this case, which may result in a decrease in analyzing rates of the two-dimensional codes.

The second example of the related art method for synchronizing the two-dimensional codes includes changing colors of the two-dimensional codes displayed on the display device and causing the receiver side to detect changes in the colors of the two-dimensional codes. However, in this method, color shades of the display device, of a camera or of illumination may adversely affect the detection of the two-dimensional codes. Accordingly, when the display device is configured to display a monochrome image so as to be adapted for amblyopia users, it may be difficult to employ the second example.

Moreover, the third example of the related art method for synchronizing the two-dimensional codes includes changing sizes of the two-dimensional codes displayed on the display device and causing the receiver side to detect changes in sizes of the two-dimensional codes. However, in this method, the user needs to readjust a focus of each of the two-dimensional codes so as to resize the two-dimensional code within an imaging screen every time the size of the two-dimensional code changes. Hence, it may be difficult to detect the changes in the sizes of the two-dimensional codes. That is, when a two-dimensional code smaller than an original two-dimensional code is displayed at a position where the original two-dimensional code has been displayed, a data transmission rate per unit area may be lowered. In this case, an image adapted for the large two-dimensional code (i.e., original two-dimensional code) within the area may need to be analyzed and hence, an analysis rate for analyzing a change in the two-dimensional code may be lowered.

### SUMMARY

According to an aspect of an embodiment, there is disclosed A terminal device serving as a receiver side of a data transmission system, the terminal device comprising:

an imaging unit configured to take an image of each of a plurality of two-dimensional codes displayed on a sender side of the data transmission system, the two-dimensional codes being converted from original information to be transmitted from a sender side of the data transmission system; and

a change detecting unit configured to determine a change in contents of the two-dimensional codes by detecting a change in a direction of each of the images taken by the imaging unit from a partial area of pictures of the images of the two-dimensional codes displayed on the sender side so as to reproduce the original information from the images corresponding to the two-dimensional codes based on the determined changes in contents of the two-dimensional codes.

The object and advantages of the invention will be realized and attained by means of the elements and combinations particularly pointed out in the appended claims.

It is to be understood that both the foregoing general description and the following detailed description are exemplary and explanatory and are not restrictive of the invention.

Additional objects and advantages of the embodiments will be set forth in part in the description which follows, and in part will be obvious from the description, or may be learned by practice of the invention.

### BRIEF DESCRIPTION OF THE DRAWINGS

FIGS. 1A, 1B and 1C are diagrams illustrating a data transmission method for transmitting data to a mobile communication terminal device according to an embodiment;

FIG. 2 is a diagram illustrating a selecting method for selecting data subject to being transmitted;

FIG. 3 is a diagram illustrating a selecting method for selecting data subject to being transmitted;

FIG. 4 is a diagram illustrating a displaying method for displaying data subject to being transmitted;

FIG. 5 is a configuration diagram illustrating a mobile communication terminal device according to an embodiment;

FIGS. 6A, 6B and 6C are diagrams illustrating areas for analyzing clipped symbols;

FIGS. 7A, 7B and 7C are diagrams illustrating a moving image of a two-dimensional code according to a first embodiment displayed by a sender side;

FIG. 8 is a flowchart illustrating two-dimensional code scanning processing to scan the two-dimensional code according to the first embodiment;

FIGS. 9A, 9B and 9C are diagrams illustrating modification of the moving image of the two-dimensional code according to the first embodiment displayed by the sender side;

FIGS. 10A, 10B and 10C are diagrams illustrating a moving image of a two-dimensional code according to a second embodiment displayed by the sender side;

FIG. 11 is a flowchart illustrating two-dimensional code scanning processing to scan the two-dimensional code according to the second embodiment;

FIGS. 12A, 12B and 12C are diagrams illustrating a moving image of a two-dimensional code according to a third embodiment displayed by the sender side; and

FIG. 13 is a flowchart illustrating two-dimensional code scanning processing to scan the two-dimensional code according to the third embodiment.

### DESCRIPTION OF EMBODIMENTS

In the following, a description is given, with reference to the accompanying drawings, of the embodiments.

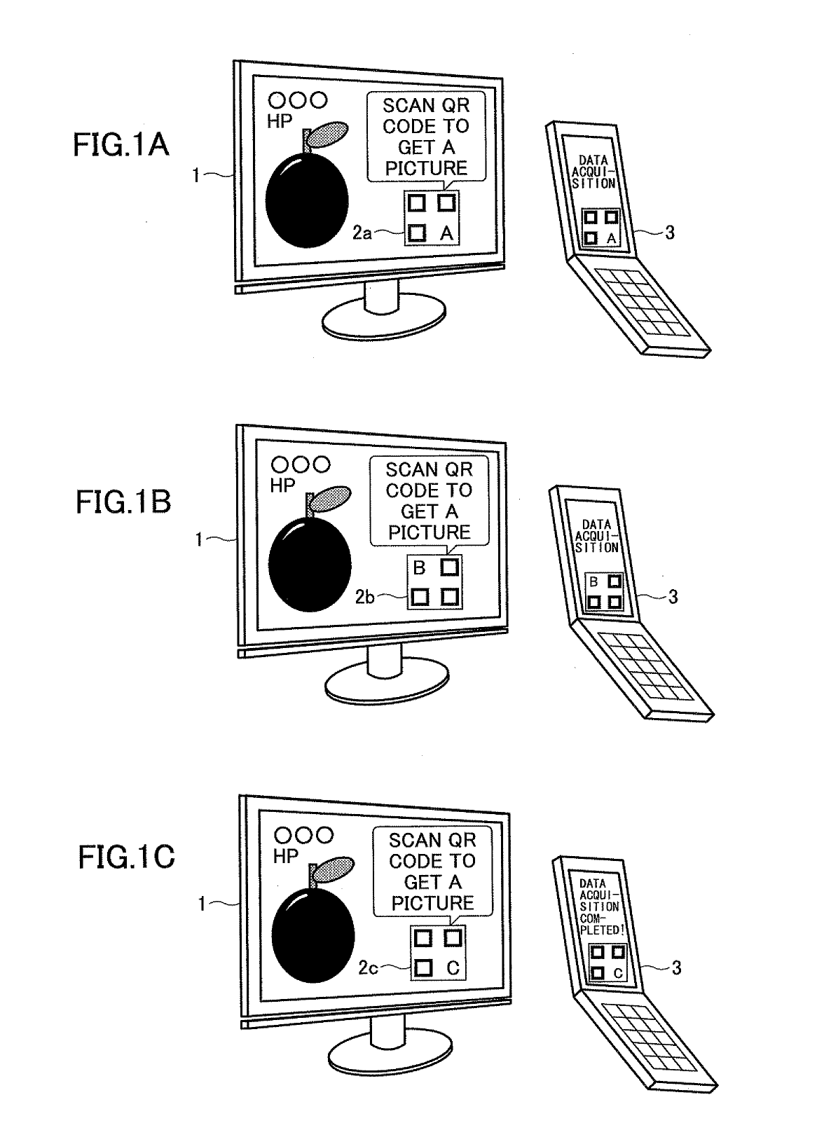

FIGS. 1A, 1B and 1C are diagrams illustrating a data transmission method for transmitting data to a mobile communication terminal device according to an embodiment. Initially, a sender side personal computer (PC) or the like divides information data subject to being transmitted such as image data or text data into plural subsets to convert the obtained plural subsets of the information into respective two-dimensional codes such as QR codes (a registered trademark). Then, the sender side PC displays the two-dimensional codes on a display part 1 such as a liquid crystal display (LCD).

FIG. 1A illustrates a two-dimensional code 2a of a first two-dimensional code displayed on the display part 1, FIG. 1B illustrates a two-dimensional code 2b of the first two-dimensional code displayed on the display part 1 and FIG. 1C illustrates a two-dimensional code 2c of the first two-dimensional code displayed on the display part 1. Note that as illustrated in FIGS. 1A, 1B and 1C, the display part 1 displays a message for encouraging the user to scan the two-dimensional code.

A receiver side mobile communication terminal device 3 scans (images), utilizing an imaging unit such as a camera, each of the two-dimensional codes 2a, 2b and 2c that exhibit a change on the display part 1. The receiver side mobile communication terminal device 3 then converts the scanned two-dimensional codes 2a, 2b and 2c into the subsets of the information to integrate the subsets of the information into one information, thereby reproducing the information such as the image data or the text data acquired from the sender side PC.

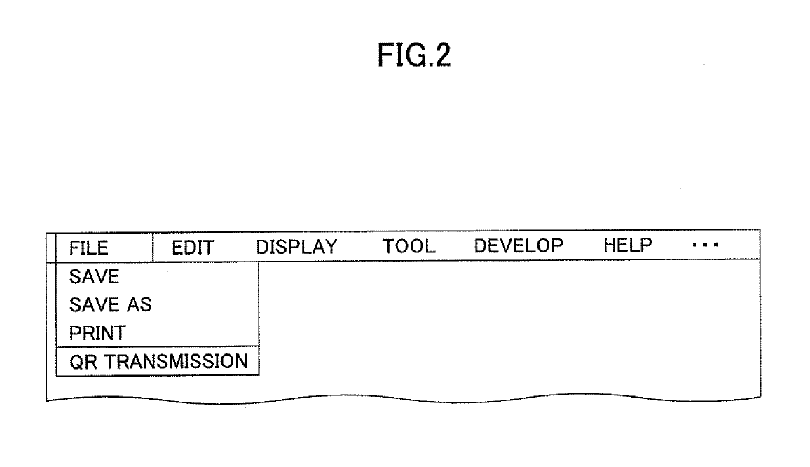

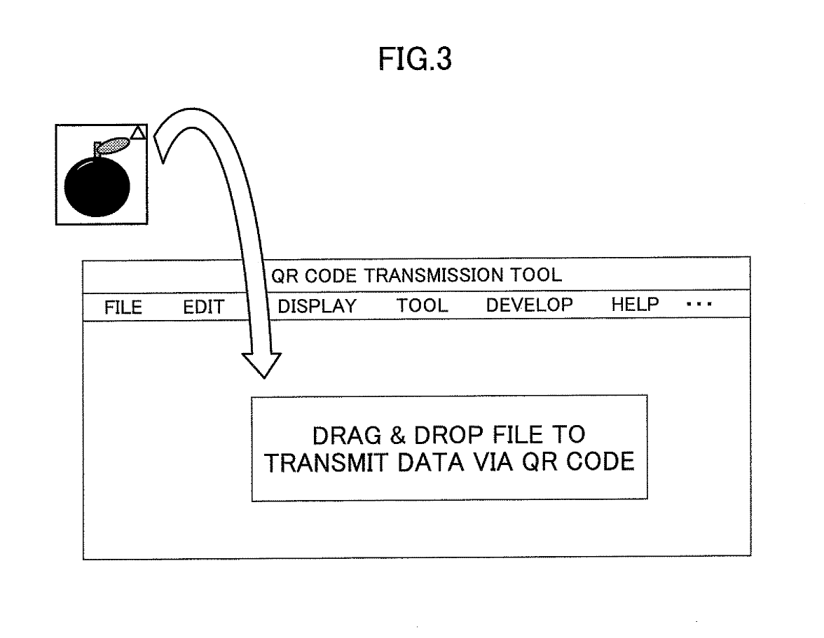

In the example of the data transmission method illustrated in FIGS. 1A, 1B and 1C, a homepage (HP) is displayed on the display part 1. Hence, data displayed on the HP are converted into plural two-dimensional codes and the plural two-dimensional codes are then transmitted to the receiver side mobile communication terminal device 3. However, the data transmission method is not limited to the example illustrated in FIGS. 1A, 1B and 1C. As illustrated in FIG. 2, the data transmission method may include selecting “QR transmission” from a menu of an activated application to display the two-dimensional codes on the display part 1. Further, as illustrated in FIG. 3, a dedicated two-dimensional code transmission tool may be prepared. Hence, the user may select a data file that the user desires to transmit by dragging and dropping the desired data file within the two-dimensional code transmission tool to convert the selected data file into plural two-dimensional codes. Note that FIG. 3 illustrates an image of a fruit as an example of the data file that the user desires to transmit.

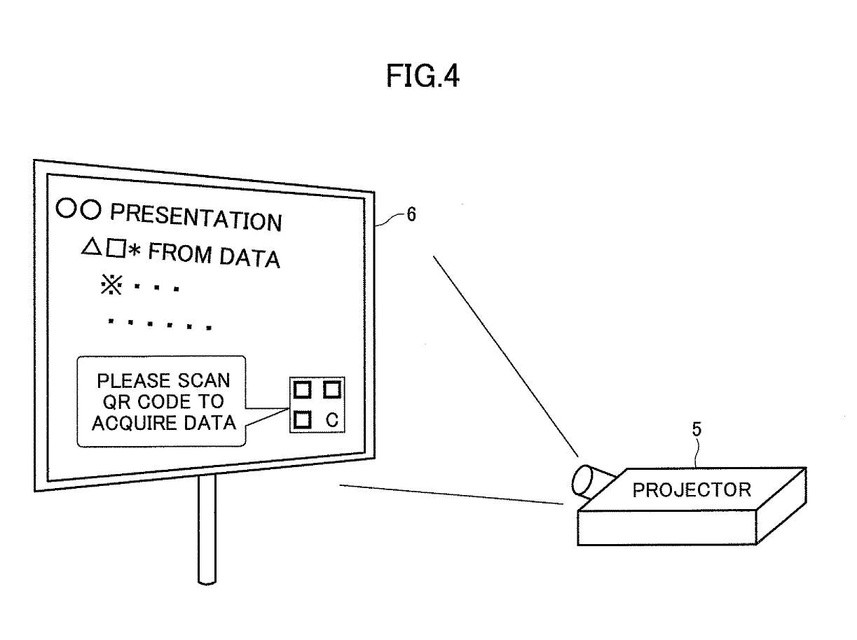

Further, when data are transmitted to numerous unspecified people, the plural two-dimensional codes may be displayed by a projector 5 on a screen 6 as illustrated in FIG. 4. In addition, the plural two-dimensional codes may also be displayed on a street display or a massive display in a concert hall so as to transmit the data to numerous unspecified people.

[Configuration of Mobile Communication Terminal Device]

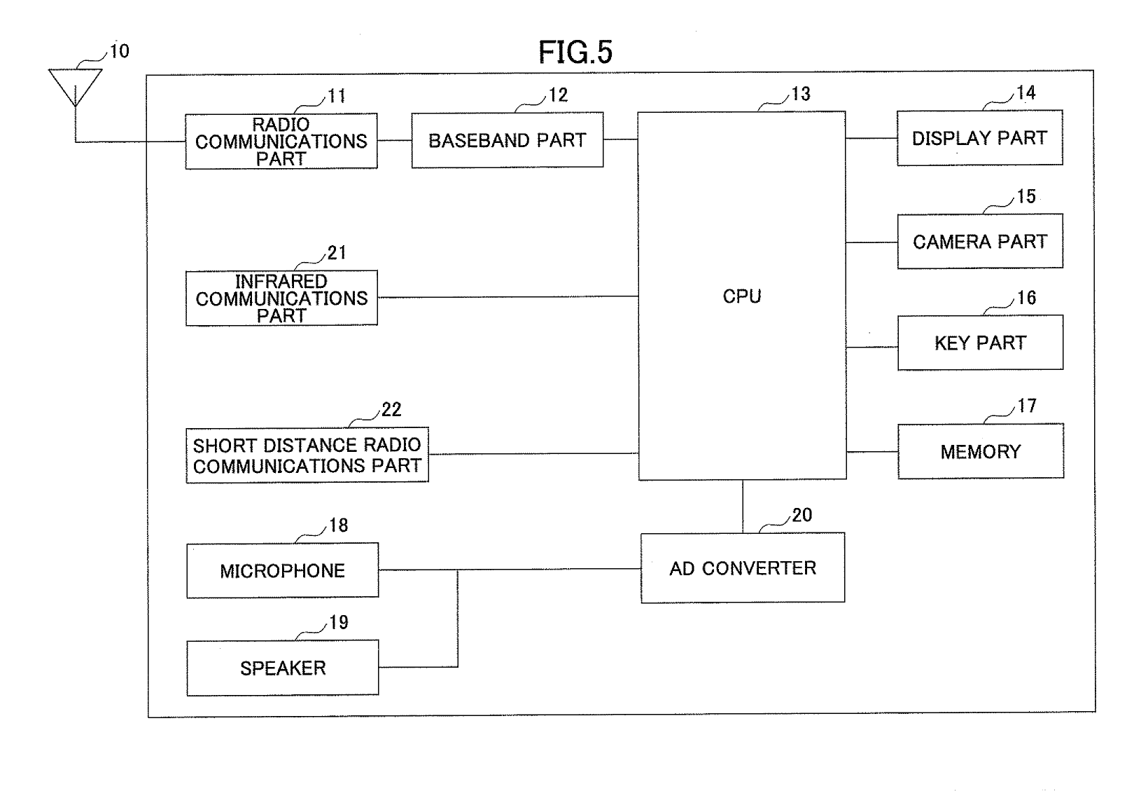

FIG. 5 is a configuration diagram of a mobile communication terminal device according to an embodiment. In this embodiment, a mobile phone is illustrated as an example of the mobile communication terminal device. As illustrated in FIG. 5, the mobile phone includes an antenna 10, a radio communications part 11, a baseband part 12, a central processing unit (CPU) 13, a display part 14, a camera part 15, a key part 16, a memory 17, a microphone 18, a speaker 19, an analog-to-digital (AD) converter 20, an infrared communications part 21 and a short distance radio communications part 22.

The radio communications part 11 is configured to modulate a transmitting signal supplied from the baseband part 12 to transmit the modulated transmitting signal from the antenna 10 to a base station. The radio communications part 11 is further configured to demodulate a received signal received from the base station to supply the demodulated received signal to the baseband part 12. The baseband part 12 is configured to encode the transmitting signal supplied from the CPU 13 and supply the encoded transmitting signal to the radio communications part 11. The baseband part 12 is further configured to decode the received signal supplied from the radio communications part 11 and supply the decoded transmitting signal to the CPU 13.

The CPU 13 is configured to execute programs of various types of processing stored in a random-access memory (RAM) of the memory 17. When an audio signal is a transmitting signal or a received signal, the CPU 13 supplies the transmitting signal from the AD converter 20 to the baseband part 12, and supplies the received signal from the base band 12 to the AD converter 20. On the other hand, when data are the transmitting signal or the received signal, the CPU 13 supplies transmitting data from the camera part 15 or the memory 17 to the baseband part 12, and supplies received data from the baseband part 12 to the display part 14 or the memory 17.

The AD converter 20 is configured to convert an analog audio signal converted by the microphone 18 into a digital audio signal to supply the digital audio signal to the CPU 13. The AD converter 20 is further configured to convert the digital audio signal supplied from the CPU 13 into an analog audio signal and supply the analog audio signal to the speaker 19, thereby causing the speaker 19 to produce sound in response to the supplied analog audio signal.

The display part 14 may be composed of a liquid crystal panel configured to display various types of character information or image information by the control of the CPU 13. The camera part 15 is configured to scan an image. An image signal obtained from the scanned image may be supplied to the CPU 13 and optionally be stored in the RAM of the memory 17. The key part 16 includes various keys such as a numeric keyboard, a speaking key, a selection key, an enter key and a clear key. An input of the key part 16 is supplied to the CPU 13.

The infrared communications part 21 is configured to transmit to or receive from other infrared communications parts of other mobile phones data including profile information and telephone directory information utilizing infrared radiation. The infrared communications part 22 is further configured to transmit to or receive from other infrared communications parts of other mobile phones data including profile information and telephone directory information utilizing infrared communications such as Bluetooth (a registered trademark).

[Two-Dimensional Code]

In the mobile communication terminal device according to the embodiment, the CPU 13 is configured to analyze a two-dimensional code scanned by the camera part 15. In this case, the CPU 13 analyzes clipped symbols within the two-dimensional code to compute a direction of an image of the two-dimensional code. Note that a rectangular QR code (a registered trademark) includes three clipped symbols arranged at respective corners as position detecting patterns. Note also that a rectangular iQR code (a registered trademark) includes a clipped symbol arranged at one corner as a position detecting pattern.

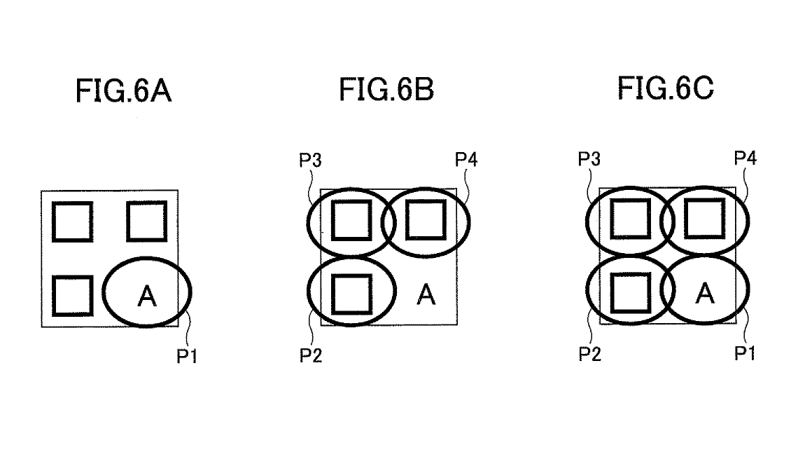

The clipped symbols may be analyzed by analyzing one encircled area P1 illustrated in FIG. 6A, or three encircled areas P2, P3 and P4 illustrated in FIG. 6B. Further, the clipped symbols may be analyzed by analyzing all the four encircled areas P1, P2, P3 and P4 illustrated in FIG. 6C.

### First Embodiment

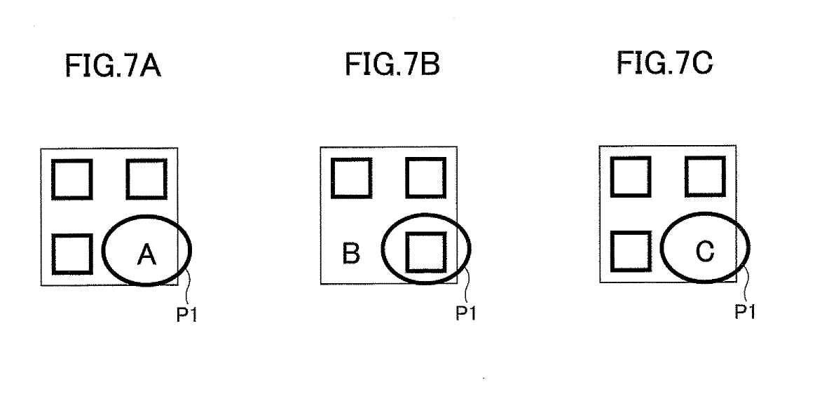

FIGS. 7A, 7B and 7C are diagrams illustrating a moving image of a two-dimensional code according to a first embodiment displayed by a sender side.

FIG. 7A illustrates an n^{th} (n is any integer) two-dimensional code image (a content A), FIG. 7B illustrates an (n+1)^{th} two-dimensional code image (a content B), and FIG. 7C illustrates an (n+2)^{th} two-dimensional code image (a content C). In the first embodiment, a QR code (a registered trademark) is employed as the two-dimensional code.

The two-dimensional code illustrated in FIG. 7A includes three clipped symbols arranged at its three corners, namely, an upper right corner, an upper left corner and a lower left corner of the two-dimensional code. The direction of the two-dimensional code image in this status represents a zero degree. The two-dimensional code illustrated in FIG. 7B includes three clipped symbols arranged at its three corners, namely, an upper right corner, an upper left corner and a lower right corner of the two-dimensional code. The direction of the two-dimensional code image in this status represents +90 degrees, which indicates a position 90 degrees rotated in a clockwise direction from the two-dimensional code image illustrated in FIG. 7A. The two-dimensional code illustrated in FIG. 7C includes three clipped symbols arranged at its three corners, namely, an upper right corner, an upper left corner and a lower left corner of the two-dimensional code. The direction of the two-dimensional code image in this status represents a zero degree, which indicates a position 90 degrees rotated in a counterclockwise direction from the two-dimensional code image illustrated in FIG. 7A.

The moving image according to the first embodiment is configured to repeat rotating the images of the plural two-dimensional codes by 90 degrees in the clockwise direction and in the counter clockwise direction. In this case, the receiver side may be able to determine whether the two-dimensional code has been changed based on whether there is a clipped symbol in the area P1 as illustrated in FIG. 6A.

Alternatively, the sender side may sequentially rotate the images of the plural two-dimensional codes by 90 degrees in the clockwise direction. In this case, the receiver side may be able to determine whether the two-dimensional code has been changed based on whether there are clipped symbols in the areas P2, P3 and P4 as illustrated in FIG. 6B. Further, the receiver side may be able to determine whether the two-dimensional code has been changed based on whether there are clipped symbols in the areas P1, P2, P3 and P4 as illustrated in FIG. 6C.

[Flowchart of Receiver Side Processing According to First Embodiment]

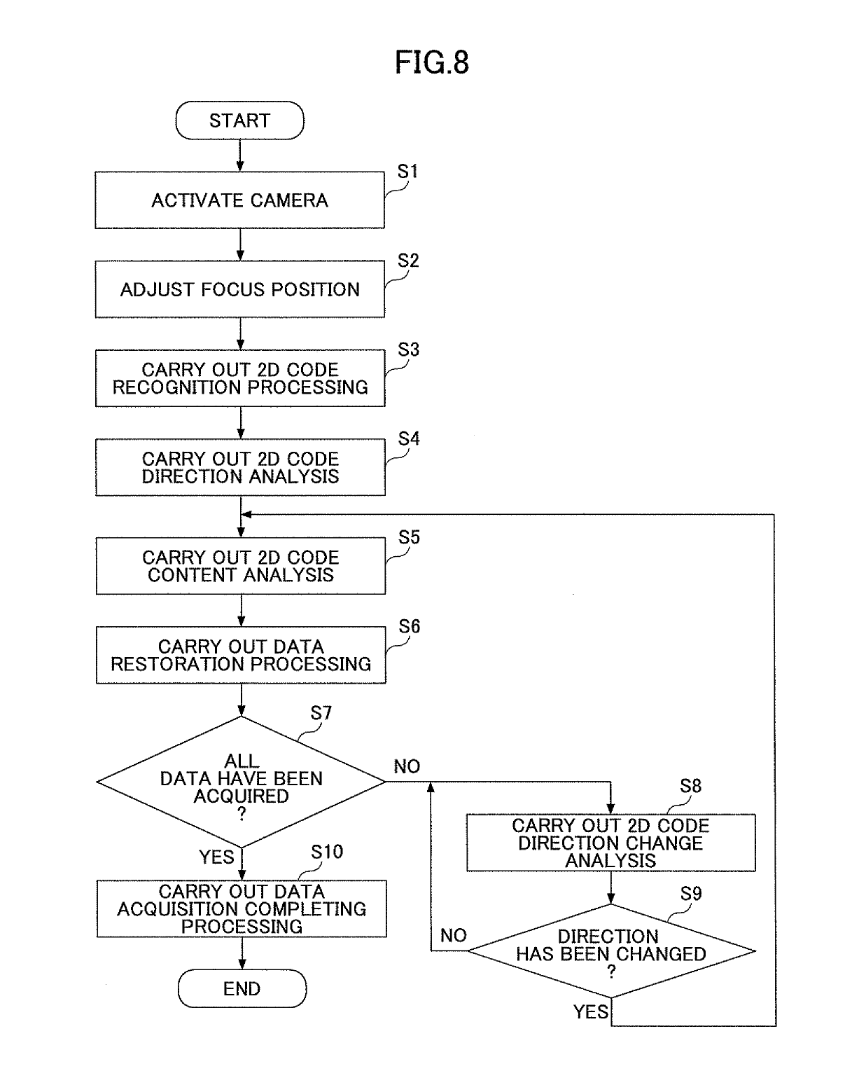

FIG. 8 is a flowchart illustrating two-dimensional code scanning processing executed by the CPU 13 to scan the two-dimensional code according to the first embodiment. A program of the two-dimensional code scanning processing is stored in the memory 17. Hence, the CPU 13 is configured to execute the program of the two-dimensional code scanning processing retrieved from the memory 17.

As illustrated in FIG. 8, the camera part 15 is activated in step S1, and a focus of the two-dimensional code is adjusted by a focus adjusting unit such as autofocus to a position at which the two-dimensional code is displayed in step S2.

The two-dimensional code is recognized by carrying out existing two-dimensional code recognition processing on an image of the two-dimensional code scanned by the camera part 15 in step S3. In the two-dimensional code recognition processing, the two-dimensional code may be recognized by detecting clipped symbols located at its three corners. Next, a direction of the two-dimensional code image is analyzed based on the clipped symbols located at its three corners in step S4.

Thereafter, a content of the two-dimensional code is analyzed in step S5. The analysis of the content of the two-dimensional code may involve recognition of whether the scanned two-dimensional code is a moving image, recognition of what number two-dimensional code of the moving image the scanned two-dimensional code is or the recognition of whether the scanned two-dimensional code is the last one of the two-dimensional codes of the moving image. The two-dimensional codes of the moving image are configured to contain such information in advance. Thereafter, data contained in the scanned two-dimensional code may be restored by carrying out data restoration processing in step S6.

Next, whether all the two-dimensional codes constituting the moving image have been acquired is determined in step S7. In step S7, whether all the two-dimensional codes constituting the moving image have been acquired is determined based on a recognition result obtained by the determination as to whether the scanned two-dimensional code is the last one of the two-dimensional codes constituting the moving image in step S5. When not all the two-dimensional codes have been acquired (“NO” in step S7), a change in the direction of the two-dimensional code is analyzed in step S8. The direction change of the two-dimensional code may be analyzed based on whether the direction of the two-dimensional code image has been changed between the two-dimensional code image rotated by zero degree and the two-dimensional code image rotated by 90 degrees. That is, whether the current direction of the two-dimensional code image obtained after carrying out the processing in step S8 has been changed from the previous direction of the two-dimensional code image obtained after carrying out the processing in step S5 is analyzed. In step S8, whether the direction of the two-dimensional code image rotated by the zero degree has been changed from the direction of the two-dimensional code image rotated by 90 degrees is determined based on whether there is a clipped symbol residing in the area P1.

In step S9, whether there is a change in the two-dimensional code image is determined. When no change has been found in the direction of the two-dimensional code image, the analysis of the content of the two-dimensional code is repeated in step S8. When a change has bee found in the direction of the two-dimensional code image, the analysis of the content of the two-dimensional code is repeated in step S5.

On the other hand, when all the two-dimensional codes have been acquired in step S7 (“YES” in step S7), data acquisition completion processing is carried out in step S10 to complete the two-dimensional code scanning processing.

In this embodiment, whether the direction of the two-dimensional code image rotated by the zero degree has been changed from the direction of the two-dimensional code image rotated by the 90 degrees is determined based on whether there is a clipped symbol residing in the area P1 in step S8, as illustrated in FIG. 6A. Accordingly, the analysis of the area P1 may be simply carried out to increase the analysis rate for analyzing the change in the two-dimensional code. Alternatively, it may be possible to increase the analysis rate for analyzing the change in the two-dimensional code based on whether there are clipped symbols in the areas P2, P3 and P4, as illustrated in FIG. 6B.

Note that in this embodiment, whether all the two-dimensional codes have been acquired is determined based on the information contained in the two-dimensional codes. However, whether all the two-dimensional codes have been acquired may alternatively be determined based on the determination as to whether the acquired two-dimensional code is the last two-dimensional code by rotating the direction of the acquired two-dimensional code image by 180 degrees with respect to the direction of the first one of the acquired two-dimensional code images.

The mobile communications terminal device may scan a new two-dimensional code every time it is generated until the last one of the two-dimensional codes is generated. Further, the mobile communications terminal device may further continue to scan unrecognized two-dimensional codes having numbers smaller than an m^{th} number at the time the last (m^{th}) two-dimensional code has been scanned and recognized. For example, scanning of two-dimensional code images may start from a second two-dimensional code image. In this case, when recognition of the second two-dimensional code image has been successful, recognition of a third two-dimensional code image has failed, recognition of a fourth two-dimensional code image has been successful and recognition of the fifth (last) two-dimensional code image has been successful, scanning may be continued until recognition of an unrecognized first two-dimensional code image and the recognition of the unrecognized third two-dimensional code image have been successful.

[Modification]

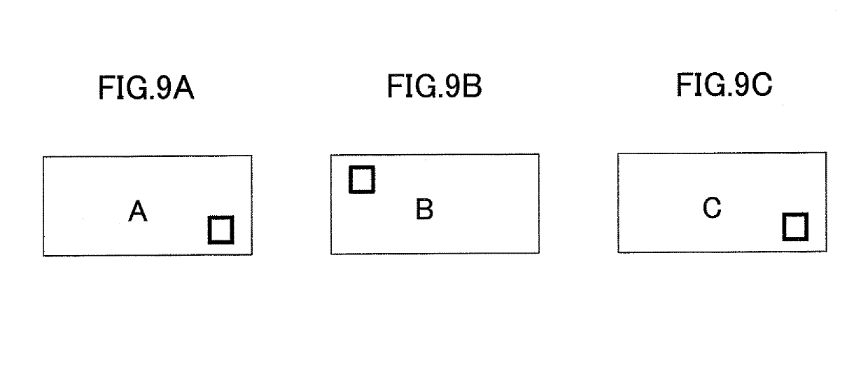

FIGS. 9A, 9B and 9C are diagrams illustrating modification of the moving image of the two-dimensional code according to the first embodiment displayed by the sender side. FIG. 9A illustrates an n^{th} (n is any integer) two-dimensional code image (a content A), FIG. 9B illustrates an (n+1)^{th} two-dimensional code image (a content B), and FIG. 9C illustrates an (n+2)^{th} two-dimensional code image (a content C). In this embodiment, an iQR code (a registered trademark) is employed as the two-dimensional code.

The two-dimensional code illustrated in FIG. 9A includes a clipped symbol arranged at a lower right corner of the two-dimensional code. The direction of the two-dimensional code image in this status represents a zero degree. The two-dimensional code illustrated in FIG. 9B includes a clipped symbol arranged at an upper left corner of the two-dimensional code. The direction of the two-dimensional code image in this status represents +180 degrees, which indicates a position 180 degrees rotated in a clockwise direction from the two-dimensional code illustrated in FIG. 9A. The two-dimensional code illustrated in FIG. 9C includes a clipped symbol arranged at a lower right corner of the two-dimensional code. The direction of the two-dimensional code image in this status represents +0 degrees, which indicates a position 180 degrees rotated in a clockwise direction from the two-dimensional code illustrated in FIG. 9B. That is, the moving image include plural two-dimensional code images that sequentially rotate by 180 degrees in the clockwise direction. In this case, the receiver side may be able to determine whether the two-dimensional code has been changed based on whether there is a clipped symbol in the area P1.

### Second Embodiment

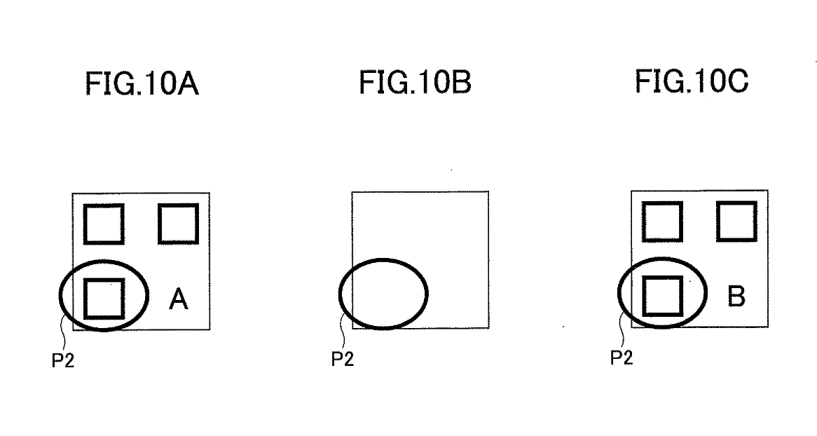

FIGS. 10A, 10B and 10C are diagrams illustrating a moving image of a two-dimensional code according to a second embodiment displayed by the sender side. FIG. 10A illustrates an n^{th} (n is any integer) two-dimensional code image (a content A), FIG. 10B illustrates an (n+1)^{th} image (a white background) of a different type, and FIG. 10C illustrates an (n+2)^{th} two-dimensional code image (a content B). In this embodiment, a QR code (a registered trademark) is employed as the two-dimensional code. The QR code is configured such that a different type of image (a white background) is sandwiched between the two-dimensional code images (contents A and C).

Note that the two-dimensional code images (contents A and C) and the different type of image (the white background) may be displayed at the same time or at different times. The analysis of the content of the two-dimensional code image may normally require a certain amount of time. Hence, a display time of the white background may be shorter than a display time of the two-dimensional code image.

The two-dimensional code illustrated in FIG. 10A includes three clipped symbols arranged at its three corners, namely, an upper right corner, an upper left corner and a lower left corner of the two-dimensional code. The direction of the two-dimensional code image in this status represents a zero degree. The different type of image illustrated in FIG. 10B includes no clipped symbols. The two-dimensional code illustrated in FIG. 10C includes three clipped symbols arranged at its three corners, namely, an upper right corner, an upper left corner and a lower left corner of the two-dimensional code. The direction of the two-dimensional code image in this status represents a zero degree. In this case, the receiver side may be able to recognize the different type of image being sandwiched between the two-dimensional codes of FIG. 10A and FIG. 10C when no clipped symbol has been detected in an area P2. Hence, the receiver side may be able to determine whether the two-dimensional code has been changed based on whether there is a clipped symbol in the area P2.

[Flowchart of Receiver Side Processing According to Second Embodiment]

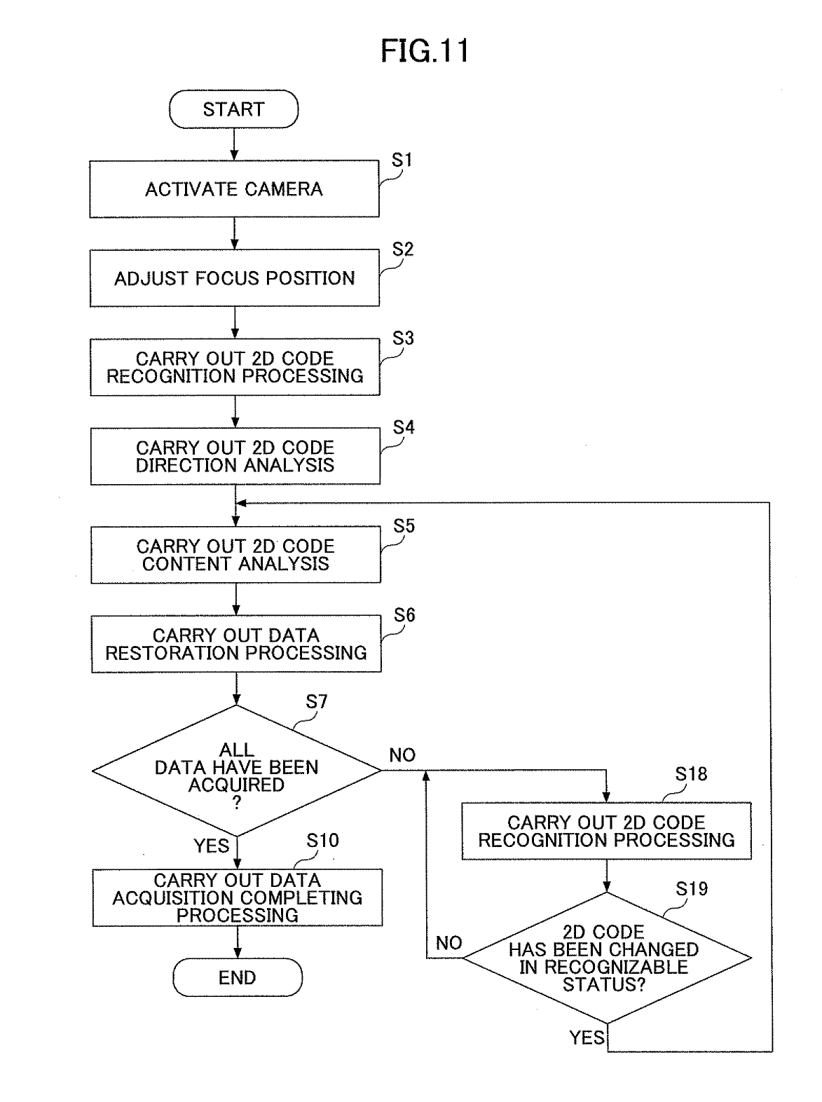

FIG. 11 is a flowchart illustrating two-dimensional code scanning processing executed by the CPU 13 to scan the two-dimensional code according to the second embodiment. In FIG. 11, components similar to those illustrated in FIG. 8 are provided with the same reference numerals. A program of the two-dimensional code scanning processing is stored in the memory 17. Hence, the CPU 13 is configured to execute the program of the two-dimensional code scanning processing retrieved from the memory 17.

As illustrated in FIG. 11, the camera part 15 is activated in step S1, and a focus of the two-dimensional code is adjusted by a focus adjusting unit such as autofocus to a position at which the two-dimensional code is displayed in step S2.

The two-dimensional code is recognized by carrying out existing two-dimensional code recognition processing on an image of the two-dimensional code scanned by the camera part 15 in step S3. In the two-dimensional code recognition processing, the two-dimensional code may be recognized by detecting clipped symbols located at its three corners. Next, a direction of the two-dimensional code image is analyzed based on the clipped symbols located at its three corners in step S4.

Thereafter, a content of the two-dimensional code is analyzed in step S5. The analysis of the content of the two-dimensional code may involve recognition of whether the scanned two-dimensional code is a moving image, recognition of what number two-dimensional code of the moving image the scanned two-dimensional code is or recognition of whether the scanned two-dimensional code is the last one of the two-dimensional codes of the moving image. The two-dimensional codes of the moving image are configured to contain such information in advance. Thereafter, data contained in the scanned two-dimensional code may be restored by carrying out data restoration processing in step S6.

Next, whether all the two-dimensional codes constituting the moving image have been acquired is determined in step S7. In step S7, whether all the two-dimensional codes constituting the moving image have been acquired is determined based on a recognition result obtained by the determination as to whether the scanned two-dimensional code is the last one of the two-dimensional codes constituting the moving image in step S5. When not all the two-dimensional codes have been acquired (“NO” in step S7), two-dimensional code recognition processing is carried out in step S18. In this case, the receiver side may be able to recognize the two-dimensional code based on the determination as to whether there is a clipped symbol in the area P2. Note that alternatively, the two-dimensional code may be recognized by carrying out processing identical to that of step S3, namely, by detecting clipped symbols located at its three corners in step S18.

In step S19, whether an unrecognizable status of the two-dimensional code has been changed into a recognizable status is determined in step S19. When the unrecognizable status of the two-dimensional code has not changed into the recognizable status, the two-dimensional code recognition processing is repeated in step S18. When the unrecognizable status of the two-dimensional code has been changed into the recognizable status, the content of the two-dimensional code is analyzed in step S5.

On the other hand, when all the two-dimensional codes have been acquired in step S7 (“YES” in step S7), data acquisition completion processing is carried out in step S10 to complete the two-dimensional code scanning processing.

In this embodiment, the two-dimensional code is recognized based on the determination as to whether there is a clipped symbol in the area P2 in step S18. Accordingly, the analysis of the area P2 may be simply carried out to increase an analysis rate for analyzing the change in the two-dimensional code.

### Third Embodiment

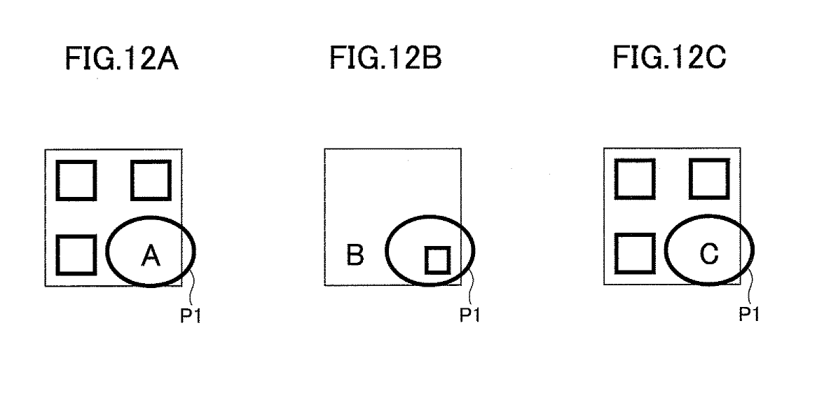

FIGS. 12A, 12B and 12C are diagrams illustrating a moving image of a two-dimensional code according to a third embodiment displayed by the sender side. FIG. 9A illustrates an n^{th} (n is any integer) two-dimensional image (a QR code (registered trademark) of a content A), FIG. 9B illustrates an (n+1)^{th} two-dimensional image (an iQR code (registered trademark) of a content B), and FIG. 9C illustrates an (n+2)^{th} two-dimensional image (a QR code (registered trademark) of a content C). In this embodiment, a QR code (a registered trademark) is employed as the two-dimensional code. The QR code is configured such that an image of a different type of a QR code formed based on a different standard (the content B) is sandwiched between the two-dimensional code images (contents A and C).

The two-dimensional code illustrated in FIG. 12A includes three clipped symbols arranged at its three corners, namely, an upper right corner, an upper left corner and a lower left corner of the two-dimensional code. The direction of the two-dimensional code image in this status represents a zero degree. The two-dimensional code illustrated in FIG. 12B includes a clipped symbol is arranged at a lower right corner of the two-dimensional code. The direction of the two-dimensional code image in this status represents a zero degree. The two-dimensional code illustrated in FIG. 12C includes three clipped symbols arranged at its three corners, namely, an upper right corner, an upper left corner and a lower left corner of the two-dimensional code. The direction of the two-dimensional code image in this status represents a zero degree. In this case, the receiver side may be able to determine a type of the two-dimensional code based on whether there is a clipped symbol in the area P1.

[Flowchart of Receiver Side Processing According to Third Embodiment]

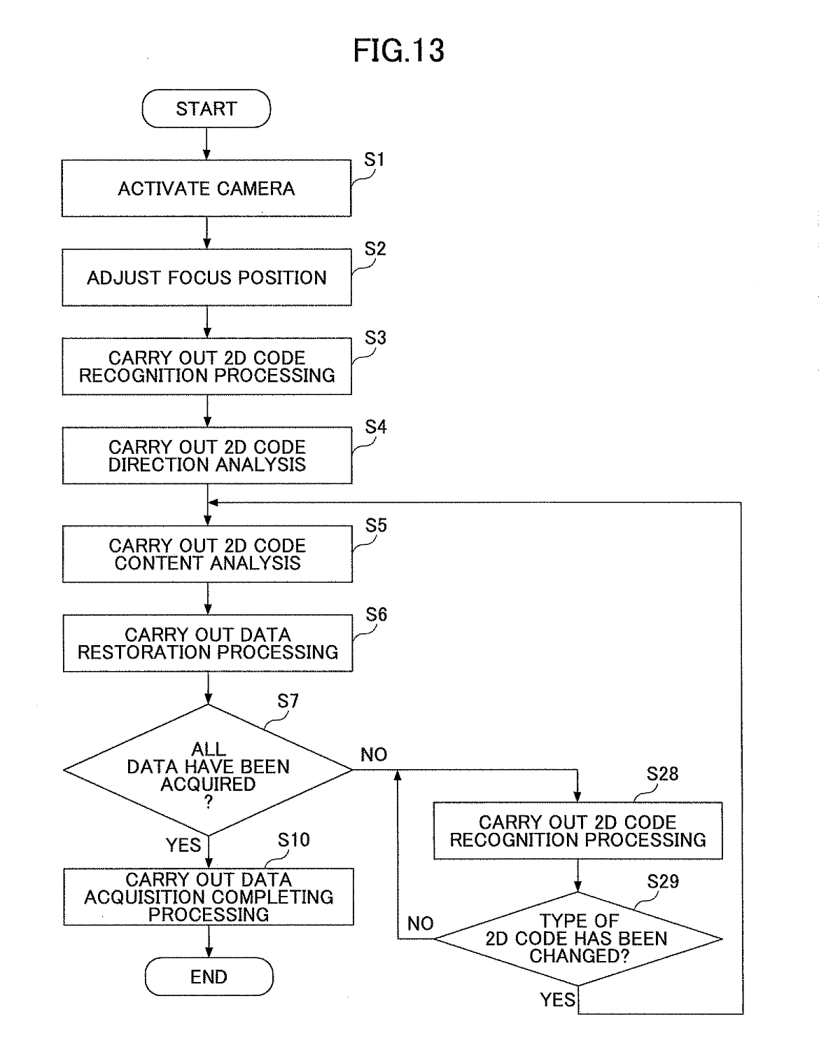

FIG. 13 is a flowchart illustrating two-dimensional code scanning processing executed by the CPU 13 to scan the two-dimensional code according to the third embodiment. In FIG. 13, components similar to those illustrated in FIG. 8 are provided with the same reference numerals. A program of the two-dimensional code scanning processing is stored in the memory 17. Hence, the CPU 13 is configured to execute the program of the two-dimensional code scanning processing retrieved from the memory 17.

As illustrated in FIG. 13, the camera part 15 is activated in step S1, and a focus of the two-dimensional code is adjusted by a focus adjusting unit such as autofocus to a position at which the two-dimensional code is displayed in step S2.

The two-dimensional code is recognized by carrying out existing two-dimensional code recognition processing on an image of the two-dimensional code scanned by the camera part 15 in step S3. In the two-dimensional code recognition processing, the two-dimensional code may be recognized by detecting clipped symbols located at its three corners. Next, a direction of the two-dimensional code image is analyzed based on the clipped symbols located at its three corners in step S4.

Note that in this embodiment, the two-dimensional code image illustrated in FIG. 12A is transmitted as a first image. However, when the two-dimensional code image illustrated in FIG. 12B is transmitted as the first image, the two-dimensional code is recognized by detecting a clipped symbol arranged at a lower right corner of the two-dimensional code in step S3 so as to analyze the direction of the two-dimensional code image in step S4.

Thereafter, a content of the two-dimensional code is analyzed in step S5. The analysis of the content of the two-dimensional code may involve recognition of whether the scanned two-dimensional code is a moving image, recognition of what number two-dimensional code of the moving image the scanned two-dimensional code is or recognition of whether the scanned two-dimensional code is the last one of the two-dimensional codes of the moving image. The two-dimensional codes of the moving image are configured to contain such information in advance. Thereafter, data contained in the scanned two-dimensional code may be restored by carrying out data restoration processing in step S6.

Next, whether all the two-dimensional codes constituting the moving image have been acquired is determined in step S7. In step S7, whether all the two-dimensional codes constituting the moving image have been acquired is determined based on a recognition result obtained by the determination as to whether the scanned two-dimensional code is the last one of the two-dimensional codes constituting the moving image in step S5. When not all the two-dimensional codes have been acquired (“NO” in step S7), two-dimensional code recognition processing is carried out in step S28. In this case, a type of the two-dimensional code is recognized based on the determination as to whether there is a clipped symbol in an area P1. Note that alternatively, the type of the two-dimensional code may be recognized by carrying out processing identical to that of step S3, namely, by detecting clipped symbols located at its three corners in step S28.

In step S29, whether the type of the two dimensional code has been changed is determined. When the type of the two-dimensional code has not changed, the two-dimensional code recognition processing is repeated in step S28. When the type of the two-dimensional code has been changed, the content of the two-dimensional code is analyzed in step S5.

On the other hand, when all the two-dimensional codes have been acquired in step S7 (“YES” in step S7), data acquisition completion processing is carried out in step S10 to complete the two-dimensional code scanning processing.

In this embodiment, the images of two different types of two-dimensional codes are alternately displayed and the receiver side determines that the two dimensional code has been switched by detecting the change in the images of the types of the two-dimensional codes and acquires information on the two different types of two-dimensional codes. However, alternatively, information on any one of the two different types of the two-dimensional codes may be acquired.

In this embodiment, the type of the two-dimensional code is recognized based on the determination as to whether there is a clipped symbol in the area P1 that is a part of the two-dimensional code image in step S28. Accordingly, the analysis of the area P1 may be simply carried out to increase the analysis rate for analyzing the change in the two-dimensional code.

Note that as a method for identifying the scanned two-dimensional code as an n^{th} two-dimensional code, an identification mark identifying the scanned two-dimensional code as the n^{th} two-dimensional code is embedded in the content of the two-dimensional code. However, the scanned two-dimensional code may alternatively be identified as the nth two-dimensional code based on a direction or transition of the direction of the image of the two-dimensional code.

According to the aforementioned embodiments and modification illustrate a transmission method utilizing the camera part 15 of the mobile communications terminal device 3. In these configurations, the mobile communications terminal device 3 may be capable of carrying out data transmission without having the infrared communications part 21 or the short distance radio communications part 22. Further, unlike the data transmission utilizing an electronic mail (Email), the transmission method according to the aforementioned embodiments and modification may be carried out without consuming communication cost.

Further, according to the aforementioned embodiments and modification, a change only in a part of the two-dimensional code may be determined. Hence, a timing at which the two-dimensional codes are synchronized may be easily determined, and a synchronization rate of the two-dimensional codes may be increased. Hence, the sender side may be capable of transmitting data for projecting an image by the projector at the presentation, displaying an image on a street display, and displaying an image on a massive display in an event venue to numerous unspecified people without concerning communication partners (i.e., the receiver side).

According to the aforementioned embodiments and modifications, the analysis rate for analyzing the change in the two-dimensional code may be increased.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal device serving as a receiver side of a data transmission system, the terminal device comprising:
an imaging unit configured to take an image of each of a plurality of two-dimensional codes displayed on a sender side of the data transmission system, the two-dimensional codes being converted from original information to be transmitted from a sender side of the data transmission system; and
a change detecting unit configured to determine a change in contents of the two-dimensional codes by detecting a change in a direction of each of the images taken by the imaging unit from a partial area of pictures of the images of the two-dimensional codes displayed on the sender side so as to reproduce the original information from the images corresponding to the two-dimensional codes based on the determined changes in contents of the two-dimensional codes.

2. A terminal device serving as a receiver side of a data transmission system, the terminal device comprising:
an imaging unit configured to take an image of each of a plurality of two-dimensional codes including a different type of an image sandwiched between the two-dimensional codes displayed on a sender side of the data transmission system, the two-dimensional codes including the different type of the image sandwiched between the two-dimensional codes being converted from original information to be transmitted from a sender side of the data transmission system; and
a change detecting unit configured to determine a change in contents of the two-dimensional codes by detecting the different type of the image sandwiched between the images corresponding to the two-dimensional codes taken by the imaging unit from a partial area of pictures of the images of the two-dimensional codes displayed on the sender side so as to reproduce the original information from the images corresponding to the two-dimensional codes based on the determined changes in contents of the two-dimensional codes.

3. The terminal device as claimed in claim 1, wherein
the change in the direction of the each of the images corresponding to the two-dimensional codes is detected based on changes in positions of position detecting patterns in the each of the images corresponding to the two-dimensional codes.

4. The terminal device as claimed in claim 2, wherein
the change detecting unit detects the different type of the image based on presence or absence of a position detecting pattern in each of the images corresponding to the two-dimensional codes.

5. The terminal device as claimed in claim 2, wherein
the different type of the image is a different type of a two-dimensional code having a standard differing from a standard of the two-dimensional codes.

6. A non-transitory computer-readable medium storing a program, which, when processed by a processor, causes a computer to execute a sequence of processing, the sequence of processing comprising:
taking an image of each of a plurality of two-dimensional codes displayed on a sender side of a data transmission system, the two-dimensional codes being converted from original information to be transmitted from a sender side of the data transmission system; and
determining a change in contents of the two-dimensional codes by detecting a change in a direction of each of the images taken from a partial area of pictures of the images of the two-dimensional codes displayed on the sender side so as to reproduce the original information from the images corresponding to the two-dimensional codes based on the determined changes in contents of the two-dimensional codes.
